(19) United States
(12) Patent Application Publication
(10) Pub. No.: US 2023/0292083 A1
(43) Pub. Date: Sep. 14, 2023

(54) Extending Geofencing to Enterprise Roaming and Neutral Host

(71) Applicant: Celona, Inc., Campbell, CA (US)

(72) Inventor: Srinivasan Balasubramanian, San Diego, CA (US)

(21) Appl. No.: 18/181,956

(22) Filed: Mar. 10, 2023

Related U.S. Application Data
(60) Provisional application No. 63/319,222, filed on Mar. 11, 2022.

(51) Int. Cl. H04W 4/021

(52) U.S. Cl. CPC H04W 4/021

(57) ABSTRACT

Geofencing information for enterprise campus sites is stored in a geofencing database. Having such geofencing information available makes it possible to save power by limiting scans to only regions that are relevant to the User Equipment (UE) doing the scanning. Dynamic credential selection is also made possible. The geofence database is learned and/or provisioned from individual enterprise deployments. As a new enterprise network is deployed, the network accesses a resource that manages the geofencing database and provides information for the newly deployed network.

### CLAIM OF PRIORITY TO PREVIOUSLY FILED PROVISIONAL APPLICATION—INCORPORATION BY REFERENCE

This non-provisional application claims priority to an earlier-filed provisional application No. 63/319,222 filed Mar. 11, 2022, entitled “Extending Geofencing to Enterprise Roaming and Neutral Host” (ATTY DOCKET NO. CEL-079-PROV) and the provisional application No. 63/319,222 filed Mar. 11, 2022, and all its contents, are hereby incorporated by reference herein as if set forth in full.

### BACKGROUND

### (1) Technical Field

The disclosed method and apparatus relate generally to wireless networks and more particular to managing identifiers within a citizen band radio service (CBRS) network.

### (2) Background

The wireless industry has experienced tremendous growth in recent years. Wireless technology is rapidly improving, and faster and more numerous broadband communication networks have been installed around the globe. These networks have now become key components of a worldwide communication system that connects people and businesses at speeds and on a scale unimaginable just a couple of decades ago. The rapid growth of wireless communication is a result of increasing demand for more bandwidth and services. This rapid growth is in many ways supported by standards. For example, 4G LTE has been widely deployed over the past years, and the next generation system, 5G NR (New Radio) is now being deployed. In these wireless systems, multiple mobile devices are served voice services, data services, and many other services over wireless connections so they may remain mobile while still connected.

Wireless networks have a wide range of applications and uses. Enterprises particularly have a great interest in implementing wireless networks at their enterprise location, and digital solutions more generally, to improve efficiency and reduce costs. For the purposes of this disclosure, an enterprise may be a business, such as a large multi-national corporation, a small business, such as a car dealership, a governmental agency, or any other organization having a particular campus on which it would be useful for the enterprise to have access to a private wireless enterprise communication network (an “enterprise network”). Enterprises benefit from optimizing their computing, storage and networking infrastructure, and improving performance of the business applications within their business location. For this purpose, wireless network systems that make effective use of the spectrum within a business enterprise for wireless communication, improve the efficiency of communication within the organization and between the organization and the external entities. This improved communication capability at the enterprise location increases business efficiency and reduces cost. Business use cases include: fixed wireless Internet service; in building private enterprise network service; mobile broadband networks; industrial IoT; educational IoT; health IoT; communications within public venues (sports stadiums, airports, shopping malls, hotels, etc.), neutral host, etc.

FIG. 1 is an illustration of a basic configuration for a communication network 100, such as a “4G LTE” (fourth generation Long-Term Evolution) or “5G NR” (fifth generation New Radio) network. Through this network configuration, user equipment (UE) 101 can connect to External Packet Data Networks (PDNs) 103 and access any of a variety of services such as the Internet, Application Servers, Data Services, Voice Services, and others.

UEs

As used herein, the term “UE” refers to a wide range of user devices having wireless connectivity, such as a cellular mobile phone, an Internet of Things (IOT) device, virtual reality goggles, robotic devices, autonomous driving machines, smart barcode scanners, and communications equipment including for example cell phones, desktop computers, laptop computers, tablets and other types of personal communications devices. In some cases, the UEs may be mobile; in other cases, they may be installed at a fixed location. For example, a factory sensor may be installed at a fixed location from which it can remotely monitor an assembly line or a robotic arm's movement. In the illustration of FIG. 1, the UEs 101 include a first mobile phone 101a, a second mobile phone 101b, a laptop computer 101c, and a printer 101d.

The UEs 101 connect wirelessly over communication links 105 to a Radio Access Network (RAN) 107 that includes a base station/access point (BS/AP) 109. One of the advantages of such networks is their ability to provide communications to and from multiple UEs and provide these wireless UEs with access to a large number of other devices and services even though the devices may be mobile and moving from location to location.

BS/APs

The term ‘BS/AP” is used broadly herein to include base stations and access points, including at least an evolved NodeB (eNB) of an LTE network or gNodeB of a 5G network, a cellular base station (BS), a Citizens Broadband Radio Service Device (CBSD) (which may be an LTE or 5G device), a Wi-Fi access node, a Local Area Network (LAN) access point, a Wide Area Network (WAN) access point, and should also be understood to include other network receiving hubs that provide access to a network of a plurality of wireless transceivers within range of the BS/AP. Typically, the BS/APs are used as transceiver hubs, whereas the UEs are used for point-to-point communication and are not used as hubs. Therefore, the BS/APs transmit at a relatively higher power than the UEs.

CBRS Networks

Another type of wireless network that recently became available for general use by enterprises at their enterprise locations is a Citizen's Broadband Radio Service (CBRS) network. These CBRS networks utilizes the CBRS radio band of 3550-3700 MHz, nominally divided into fifteen channels of 10 MHz each. Particularly, the FCC recently approved use of the CBRS band of the frequency spectrum and finalized rules (Rule 96) that allow general access to the CBRS band. The CBRS rules set forth detailed requirements for the devices that operate in a CBRS network and how they communicate. CBRS supports both LTE and 5G devices.

FIG. 2 is a diagram of a wireless communication network implemented as an enterprise network using a CBRS system. A plurality of BS/APs 201a, 201b, 201c, 201d are deployed in an enterprise location 200. It should be noted that throughout this disclosure, a reference string (such as “201a”) used to identify a feature in a figure, having a string of numeric characters followed by one or more alphabetic characters, identifies a feature of the figure that is similar to other features in the figures having the same numeric string of characters. For example, the BS/AP 201a is similar to the BS/AP 201b, 201c and 201d. Furthermore, a reference string having only the numeric string (i.e., lacking the alphabetic characters) refers collectively to all of the features having the same numeric string. For example, the BS/AP 201 refers collectively to all four of the BS/APs 201a, 201b, 201c and 201d.

In FIG. 2, each BS/AP 201 has a range, defining a wireless coverage area. The BS/APs 201 may be CBSDs in a CBRS system. A first UE 202a is wirelessly connected to a first BS/AP 201a, which is providing service to it. A second UE 202b is wirelessly connected to a second BS/AP 201b, and is providing service to that second UE 202b. Other UEs 202, which connect to the BS/APs 201, are shown in the enterprise location 200. All the BS/APs 201 are connected to a PDN 220 by any appropriate communication means, such as wire, fiber optic, and wireless radio. The PDN 220 provides a connection to an operator network 222 that includes an Oracle (OAM) Server 207, a SON assist unit 208, a Domain Proxy 209, an Automatic Configuration Server (ACS) 210 and a Location Database 211, all of which are connected to each other within the operator network 222 by any appropriate means. The MNO network is connected to an SAS 212, which is connected to a Spectrum Database 213 that includes data regarding the spectrum that SAS 212 is managing. Collectively, the SAS 212 and the Spectrum Database 213 are referred to as a Spectrum Management Entity (SME) 214.

In some of the literature, BS/APs 201 within a CBRS network are termed “CBSDs”, and UEs 202 are termed End User Devices (EUDs). CBSDs are fixed Stations, or networks of such stations, that operate on a Priority Access (PA) or General Authorized Access (GAA) basis in the CBRS band consistent with Title 47 CFR Part 96 of the United States Code of Federal Regulations (CFR).

The CBRS rules require that a Spectrum Access System (SAS) allocate spectrum to the CBSDs to avoid interference within the CBRS band. The Spectrum Access System (SAS) is a service, typically cloud-based, that manages the spectrum used in wireless communications of devices transmitting in the CBRS band, in order to prevent harmful interference to higher priority users such as the military and priority licensees. A CBRS device (CBSD) needs authorization from the SAS before starting to transmit in the CBRS band. Even after authorization, the SAS may suspend or terminate authorization of one or more the channels previously authorized.

Regardless of complexities, the CBRS band provides an opportunity to create new wireless networks, and there is a desire for utilizing and making maximum use of spectrum in the CBRS band while following the rules pertaining the CBRS usage, including effectively responding to directions from the SAS.

FIG. 3 is an illustration of some of the components of various identifiers and the source of those components. Within CBRS networks, several identifiers are used for various purposes. These include a network identifier (NID), home network identifier (HNI), a shared HNI (SHNI), an international mobile subscriber identifier (IMSI), an E-UTRAN cell global identifier (ECGI), cell identifier (Cell-ID), a global unique mobility management entity (MME) identifier (GUMMEI), a tracking area identifier (TAI) and a tracking area code (TAC). Each of these will be discussed below. It should be noted that this is not an exhaustive list of the identifiers used in CBRS networks, but merely notes some of the identifiers that are discussed in this disclosure.

The NID for a CBRS network is based on a closed subscriber group identifier (CSG-ID) and supplements a shared home network identifier (SHNI). Taken together, the NID and the SHNI can provide a globally unique identify for a single SHNI network.

The SHNI is a specific combination of a 3-digit Mobile Country Code (MCC) and a 3-digit Mobile Network Code (MNC) that that together indicate that the network is using a SHNI. This code is shared by many operators, thus the name “shared”. Accordingly, the SHNI is not unique to a single operator. At present there is just one such number (315-010), but there could be more in the future.

The IMSI is a 15-digit identifier and is stored in the subscriber identification module (SIM)/universal integrated circuit card (UICC) inserted or embedded in a UE. For devices provisioned for an SHNI network, the IMSI comprises the SHNI (i.e., as the MCC+MNC) concatenated with the MSIN (which comprises an IMSI block number (IBN) and user identification number (UIN)). Devices with an IMSI based on a non-shared HNI that roam into an SHNI Network (e.g. NHN) could continue to use their existing IMSI.

Every subscriber has an IMSI stored within their ‘smart card’ (SIM/UICC) or embedded in the device (eUICC). This 15-digit IMSI forms a globally unique wireless subscription identity consisting of HNI+MSIN (Mobile Subscription Identification Number). Normally an operator is assigned an HNI for exclusive use, and is responsible for assignment of the MSIN codes to subscribers. However, for an SHNI, MSIN is further broken down into IBN+UIN. A CBRS operator that has subscribers (i.e., ‘smart cards’ or UICC for each subscription, whether removable or embedded) is responsible for obtaining at least one IBN for their exclusive use. The SHNI+operator-specific IBN then forms the globally unique operator identifying IMSI. The CBRS operator is responsible for creating unique identifiers by allocating a different UIN to each subscriber/subscription. If the CBRS operator fails to obtain an operator-specific IBN for its subscribers, then the global uniqueness of their IMSIs is no longer guaranteed.

The EGCI is used to uniquely identify every LTE base station (eNodeB). The EGCI is composed of a NID (sometimes referred to as a PLMN-ID) and Cell ID. For the CBRS Network, the SHNI is used as the PLMN-ID within the ECGI.

The Cell-ID includes a macro eNB ID for the particular eNB.

When a Chose Your Own Device (CYOD) associated with an enterprise with an MNO subscription is issued to a given user who works on a campus, and when neutral host networks are deployed in several building along the route the user takes in and out of the enterprise campus, the device can “ping-pong” between the macro network and enterprise networks along the route. This will cause disruption in service and also increased battery drain on the device.

Accordingly, it would be advantageous to provide a system that can assist in ensuring that a UE does not attempt to gain access to a network to which it is not likely to maintain service.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is an illustration of a basic configuration for a communication network.

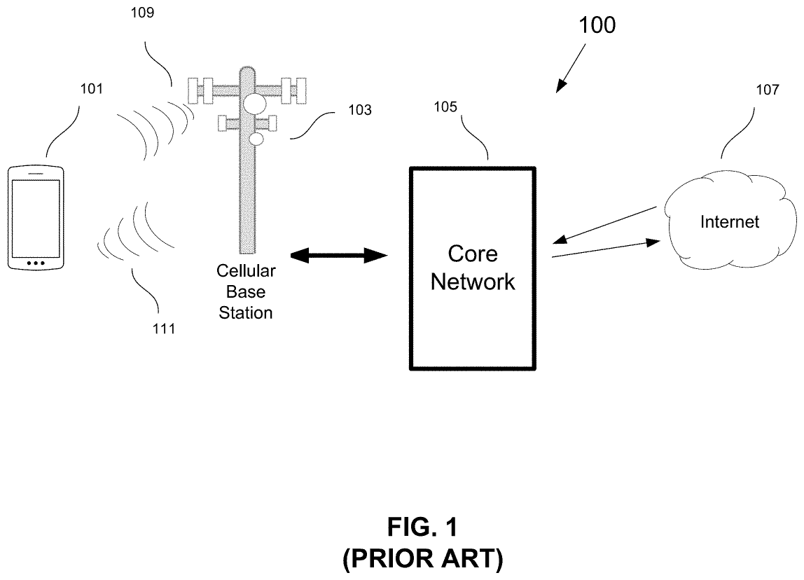

FIG. 2 is a diagram of a wireless communication network implemented as an enterprise network using a CBRS system.

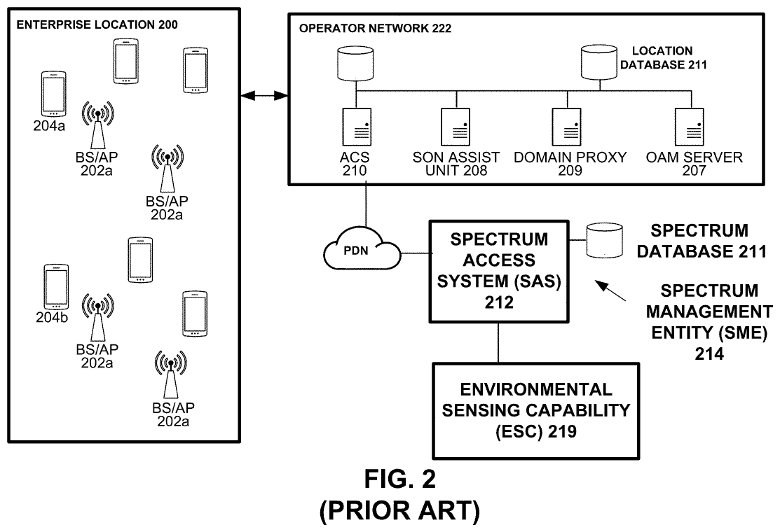

FIG. 3 is an illustration of some of the components of various identifiers and the source of those components.

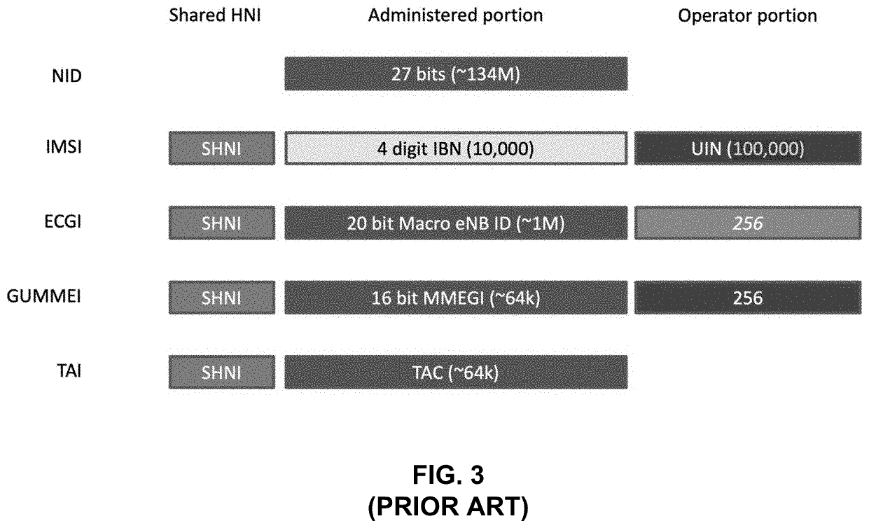

FIG. 4 shows relevant identifiers and some provisioning information.

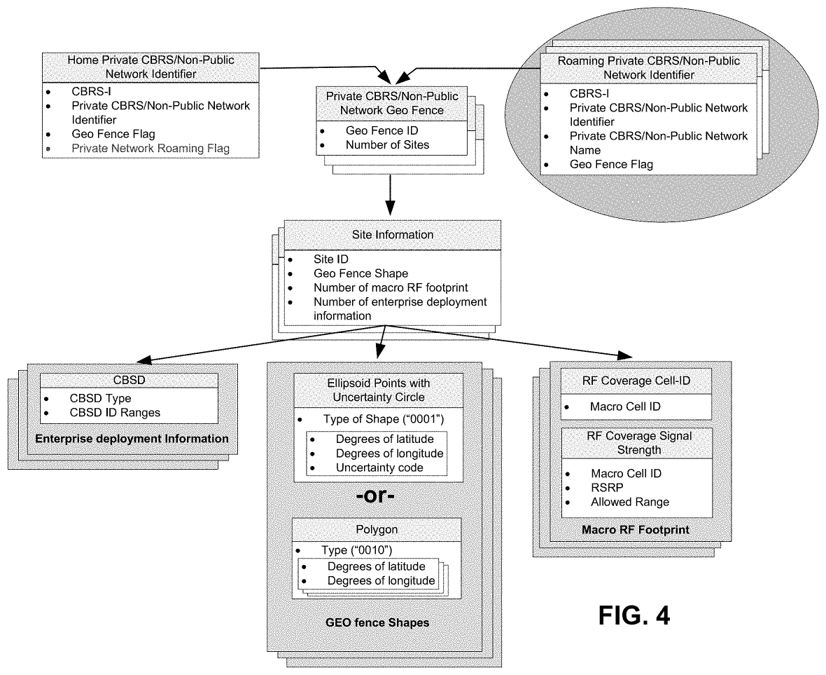

FIG. 5 shows the addition of an MNO PLMN-ID having a list of MNO PLMN-IDs as part of the enterprise deployment information.

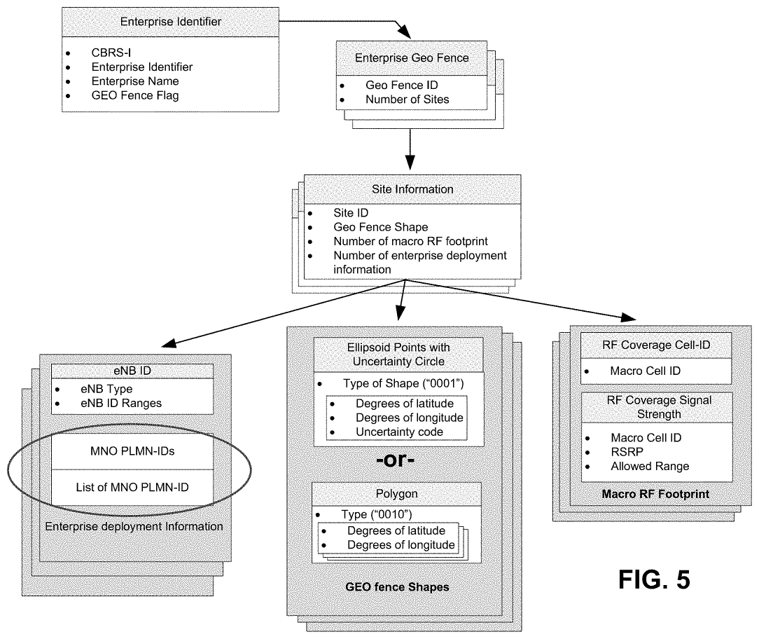

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

### Geofencing

In some embodiments, geofencing information for enterprise campus sites is stored in a geofencing database. Having such geofencing information available makes it possible to save power by limiting scans to only regions that are relevant to the UE doing the scanning. Furthermore, dynamic credential selection is made possible. In some embodiments, the geofence database is learned and/or provisioned from individual enterprise deployments. That is, in some embodiments, as a new enterprise network is deployed, the network accesses a resource that manages the geofencing database and provides information for the newly deployed network. In some embodiments, a UE learns geofencing for preferred enterprise campuses locally. For example, in some embodiments, when a UE camps on an enterprise network BS/AP, the UE will receive geofencing information for the enterprise network. In addition, the UE may receive geofencing information for neighboring networks as well. In some such embodiments, the UE is capable of interfacing with a geofencing database management entity and providing information to that entity to allow the geofencing database to be updated with information related to the enterprise network. This information can be shared with a server for crowdsourcing either by the UE directly or through the geofencing database.

In some embodiments, enterprise campuses have building level geofencing to allow a UE to appropriately transition across MNO and enterprise networks. When a UE enters a building, geofencing information allows the UE to transition from an MNO to the appropriate enterprise network. In some embodiments, using GPS based geofencing alone impacts the UE's power consumption, since the UE must continuously determine its GPS location. Accordingly, an additional method for determining the location of the UE may be employed to reduce the amount of power consumed by the UE. In some embodiments, the GPS location that is marked during the deployment of a gNB/eNB does not necessarily provide the actual coverage of the enterprise network nor coverage of the macro MNO network for different service providers that might be necessary for determining the appropriate transition points between the two networks. However, in some embodiments, part of the deployment procedures includes marking the extremities of the campus.

In some embodiments, the database uses a secure key-based enterprise network identifier. In some embodiments, further classification of the enterprise network is performed to allow a distributed campus within an enterprise to be identified and managed based on the GPS location of the enterprise network and UEs that enter the enterprise campus.

In some embodiments, a geofencing database receives and stores some or all of the following information which is associated with each enterprise network identifier and GPS location: (1) the eNBs and their associated GPS locations; and (2) for each MNO: (a) the cell IDs of MNO networks near the campus; and (b) one or more of the reference signal receive power (RSRP) values (i.e., the average power received from a single Reference signal) of the active and candidate macro MNO Cell IDs radio signature that can be used as an entry point into a campus. In some embodiments, individual signatures for each entry point to the network campus are retained independently to allow each such entry point into the campus to be recognized. In some embodiments, the GPS information associated with each of the radio signatures are also maintained in the GPS database.

### Geofencing Information Provided to the UE

In some embodiments, the UE queries the database, providing to the database the preferred enterprise network identifier and the UE's current location. The database responds with a set of radio signatures associated with the closest enterprise campus. In some embodiments, the radio signatures are provided with a set of locations that are typically visited by users. In some embodiments, this is associated with weights used as a time series to determine a campus entry and exit point. In some embodiments, the GPS information is provided as an aggregate. In some cases, the information provides a “trilateral” center of the campus with a radial distance that is used to determine the campus boundaries. In some cases, a set of GPS points are provided along with the radial distances to assist in identifying the boundaries. In some embodiments, the information provides a segment-linear boundary with a set of GPS points with straight lines connecting each of the dots marking the boundary.

### UE Behavior in Geofencing

In some embodiments, a UE runs scans for enterprise networks based on “feed-forward classification”. In some such embodiments, the radio signatures are used as a static signature. In some embodiments, the radio signatures are used as a time series along with the weights provided. In some embodiments, GPS information is used if the radio signatures are not available or the identity cannot be determined from the MNO network radio signature. In some embodiments, if neither the radio signature nor a GPS location is available, the UE performs sawtooth based scans with a configurable timer determining the amount of time between scans, as well as the time between initiating the sawtooth pattern.

In some embodiments, to reduce the amount of data to be sent to the UE, one or more of the following methods can be employed. In some embodiments, for enterprises with multiple sites, the information is recorded on a site basis and the information is provide to the UE based on the UEs current location, including sites in the proximity of the UE. The GPS information of the deployed CBSDs is used to determine a combined representation of a set comprising a location of a center and a radius about that center. In some embodiments, this is stored as a single entry. In some embodiments, the CBSD is stored with a maximum+/−50 m error in the GPS location. Nonetheless, most deployments define the CBSD GPS location with greater accuracy than the maximum+/−50 m error. In some embodiments, the expected error in the GPS information is also provided as part of the information provided at the time the enterprise is deployed (or the time an additional BS/AP is added to the network). The expected error may be used to manage the definition of the geofence.

In another embodiment, GPS locations of the campus extremities are collected and unified into a small set of entries. As part of the deployment process, radio signature of the MNO networks are collected. The information in the radio signature may consist of a set comprising {Channel, Cell ID, RSRP range}. In some embodiments, there are several points on campus where this information is collected, ideally along the extremities of the campus. This information is unified to have a set of MNO network pilots along with their RSRP ranges.

In some embodiments of the disclosed method and apparatus, arbitration is allowed across available networks of MNO, enterprise LTE/NR and WiFi networks based on subscriptions and user preferences. A UE may have several subscriptions: MNO, Enterprise LTE/NR, and Wi-Fi. In some instances, devices prefer Wi-Fi camping over any LTE/NR networks, including the enterprise LTE/NR networks. In some embodiments, the UE identifies policies for the UE to optimally use the MNO, Enterprise LTE/NR, and Wi-Fi based on the UE preferences/subscriptions. In some embodiments, the UE can specify policies that can be defined by the enterprise campus IT, potentially influenced by MNOs to define the preference of UE operations across MNO, enterprise LTE/NR, and Wi-Fi networks. These policies will depend on the services/applications. The policies can be static or dynamic based on the realtime conditions.

In some embodiments, provide the ability to dynamically select from among the available enterprise credentials stored on the UE. The UE will have multiple enterprise credentials on the device stored as embedded credentials. Rather than requiring the user to identify the specific embedded credential to use, the preference is based on the geofenced information to select the appropriate credential to use for the associate with the enterprise while on a specific campus.

Accordingly, in such embodiments, geofencing and other information is used to select the appropriate credential from among the available enterprise credentials. It is possible for the UE to be in the vicinity of multiple enterprises with overlapping geofences. Some embodiments of the disclosed method and apparatus are methods of dynamic eSIM credential selection within and across geofenced areas.

Accordingly, the UE can be provisioned with multiple independent private credentials. Roaming allows the UE to find other networks where access is permitted for a provisioned credential. In accordance with some embodiments, provisioning of enterprise related information, including the geofencing is performed. The industry specification TS-1004 specifies the preferred location and enterprise deployment information (CBSD IDs, NIDs) to be allowed networks. In accordance with some embodiments of the disclosed method and apparatus, the UE avoids any other networks not included in an allowed list. When roaming with a single credential is allowed, provisioning in the UE is required to identify the roaming scenarios. The UE needs to be able to identify which networks are ‘home’ enterprise networks and which are ‘roaming’ enterprise networks. The presently disclosed method and apparatus provides a clear mechanism of provisioning this information in the UE. It is important to associate the provisioned information with the single credential. Retaining a hierarchy of the database that includes both home and roaming network information will be better aligned for the UE implementation. Also from the network side, associating provisioning information with a signal credential allows a uniform behavior across all UE to be defined, by pushing all the required information from a single request based on the home network identifiers provided from the UE on an enterprise information request.

With the enterprise information associated with specific campuses already defined for private network subscriptions, in accordance with the disclosed method and apparatus, the same information is used and the device is associated with an MNO subscription to be provisioned and preferred enterprise campuses where neutral hosts are deployed are announced. This allows the UE to avoid camping onto drive-by/walk-by neutral host networks and rather allows the UE to associate with preferred neutral host deployments.

In some embodiments, the current behavior is not changed from the macro network management of the device transitions to/from the neutral host networks, but rather provides additional information to the UE that can be used for device camping optimizations.

In some embodiments, the UE is provisioned with both the MNO and enterprise subscriptions. In some such embodiments the UE with the enterprise information provisioned with the enterprise subscription can be leveraged with the knowledge of the neutral host deployments to optimize system camping. In some embodiments in which MNO coverage is weak or non-existent, the UE can transition and operate both the credentials on the enterprise network employing a same-channel Dual SIM, Dual Standby (DSDS) operation.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
a) determining whether enterprise information is defined for a specific campus; and
b) using the enterprise information and associating a User Equipment (UE) with a Mobile Network Operator subscription to be provisioned to announce preferred enterprise campuses where a neutral host is deployed.
